(19) United States
(12) Patent Application Publication
(10) Pub. No.: US 2026/0292279 A1
(43) Pub. Date: Sep. 24, 2026

(54) DISTRIBUTED STORAGE OF CONTENT ACROSS STORAGE SUBSYSTEMS

(71) Applicant: Comcast Cable Communications, LLC, Philadelphia, PA (US)

(72) Inventors: Christopher LINTZ, Denver, CO (US); Alexander GILADI, Denver, CO (US); Garey HASSLER, Castle Pines, CO (US); Justin LUNA, Arvada, CO (US)

(21) Appl. No.: 19/689,602

(22) Filed: May 27, 2026

Related U.S. Application Data
(63) Continuation of application No. 16/892,921, filed on Jun. 4, 2020, now abandoned.

(51) Int. Cl. H04N 21/2389; H04N 21/218; H04N 21/235

(52) U.S. Cl. CPC H04N 21/23892; H04N 21/2181; H04N 21/2353; H04N 21/23895

(57) ABSTRACT

Portions of different versions of a content asset may be stored in a manner that reduces the impact on viewing experience in the event of a failure of one of a plurality of storage subsystems of a content storage system. The portions of different versions of the content asset, which may be associated with a same portion of the playback time of the content asset, may be stored in different storage subsystems. If the storage subsystem storing a portion of one of the versions being retrieved for playback encounters a problem, a user device may access a corresponding portion of a different version stored on a different one of the storage subsystems.

### CROSS-REFERENCE TO RELATED APPLICATIONS

This application is a continuation of U.S. application Ser. No. 16/892,921, filed Jun. 4, 2020, which is incorporated herein by reference in its entirety.

### BACKGROUND

Many content providers, such as cable television and satellite television providers, provide both Video On Demand (VOD) and Digital Video Recording (DVR) services to their customers. In connection with such services, one or more versions of a content asset, such as an episode of a television program or a movie, may be stored on a content storage system that may include multiple storage subsystems communicatively connected by a network. In such a content storage system, versions of a particular content asset are typically stored on a storage subsystem associated with the user. When the user desires to view the recorded content asset, portions of the content asset may be retrieved from the storage subsystem and sent to a user device for playback, typically using a streaming process, such as adaptive bitrate streaming. When a storage subsystem of a content storage system encounters problems during playback, the user experience can be affected. Hence, improved methods of storing content are needed.

### SUMMARY

Systems and methods are described herein for improved storage of different versions of a content asset across a plurality of storage subsystems of a content storage system. Portions of different versions of a content asset may be stored in a manner that reduces the impact on viewing experience in the event of a failure of one of the plurality of storage subsystems. In particular, portions of the different versions of a content asset, which are associated with a same playback time of the content asset, may be stored in different storage subsystems. By storing the portions of at least some of the different versions of a content asset, associated with a same playback time, to different storage subsystems, no one storage subsystem stores all the corresponding portions of all of the versions. In this manner, if the storage subsystem from which a portion of one of the versions is being retrieved for playback encounters a problem, a user device can access a corresponding version of a different stream stored on a different one of the storage subsystems. For a different period in time associated with the content asset, the content storage system may change which of the storage subsystems are storing the portions of the different versions of the content asset. This may further enhance the resiliency of the system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure

### BRIEF DESCRIPTION OF THE DRAWINGS

The following drawings show generally, by way of example, but not by way of limitation, various examples discussed in the present disclosure. In the drawings:

FIG. 1 shows a first example system;

FIG. 2 shows a second example system;

FIGS. 3A-3C show content assets stored in an example storage subsystem;

FIG. 4 shows another example system;

FIG. 5 shows an example method;

FIG. 6 shows another example method;

FIG. 7 shows still another example method;

FIG. 8 shows a set of example storage subsystems;

FIG. 9 shows a new example storage subsystem added to a set of example storage subsystems;

FIG. 10 shows another set of example storage subsystems;

FIG. 11 illustrates an example timeline associated with a plurality of example storage subsystems;

FIG. 12 shows another example timeline associated with the plurality of example storage subsystems;

FIG. 13 shows another example method; and

FIG. 14 shows an example computing device.

### DETAILED DESCRIPTION

A content storage system may receive content and store the content to one or more storage subsystems. A storage subsystem may comprise one or more storage devices that store and maintain content. A storage subsystem may comprise a partition of a content storage system. A storage subsystem may have built-in redundancy to prevent data loss. Examples of redundancy may comprise, but are not limited to, erasure encoding, 2-way replication, and a Redundant Array of Inexpensive Disks (RAID).

A content asset may comprise one or more of linear content, non-linear content, video content, audio content, multi-media content, a movie, a television show, a presentation a song, an album, a live broadcast, recorded content, stored content, or any other form of content a user may wish to consume. A content asset may comprise one or more versions of the content, each of which may be referred to as a stream. Each version may comprise a different encoding of the content asset. Each version may have properties that differ from other versions, such as a different bitrate, compression technique, compression ratio, resolution, frame rate, video quality (for video), number of channels, or sampling rate (for audio). Each version of a content asset may comprise a plurality of portions. Each portion may comprise one or more segments, sometimes referred to as chunks, which may be independently accessible for playback on a user device. A version, or stream, of a content asset may be described in a manifest, and a user device may use the manifest to request segments of a version for playback on the user device. The user device may select a version for playback based on its properties and/or current network conditions. The user device may periodically reevaluate its selection of version for playback and may shift to a different version, or stream, due to changing network conditions. For example, the user device may switch to a version of the content asset having a different bitrate. This approach may be referred to as multi-rate streaming or adaptive bitrate (ABR) streaming. Example implementations of adaptive bitrate streaming techniques include MPEG DASH (Dynamic Adaptive Streaming over HTTP) and Apple HLS (HTTP Live Streaming).

In a content storage system, portions of the various versions of a content asset may be randomly stored across a plurality of different storage subsystems. However, in such a system all of the portions of the different versions associated with a same playback time could end up stored on the same storage subsystem. If all of the portions for the same playback time are stored on the same subsystem, and that subsystem encounters a problem (e.g., the subsystem goes down or becomes inaccessible), a user device may not be able to access a portion of the content asset during that playback time. This may result in a poor viewing experience.

Systems and methods are described herein for improved storage of portions of different versions of a content asset across a plurality of storage subsystems. Portions of different streams of a content asset may be stored in a manner that reduces the impact on viewing experience in the event of a failure of one of the plurality of storage subsystems of the content storage system. In particular, portions of each of the different versions of a content asset, which may be associated with a same portion of the playback time of the content asset, may be stored in different storage subsystems. In this manner, if the storage subsystem from which a portion of one of the streams is being retrieved for playback encounters a problem, the user device can access a corresponding portion of a different version stored on a different one of the storage subsystems.

By storing the portions of at least some of the different versions of a content asset, associated with a first time period, to different storage subsystems, no one storage subsystem stores all the corresponding portions of all of the versions. For a different period in time associated with the content asset, the content storage system may change which of the storage subsystems are storing the portions of the different streams of the content asset. This may further enhance the resiliency of the system.

As described above, each version (e.g., stream) of a content asset may comprise a different encoding of the content asset. For example, each stream may comprise a version of the content asset encoded at a different bitrate. Other properties of a content asset that may differ among the versions include compression technique, compression ratio, resolution, frame rate, video quality (for video), number of channels, or sampling rate (for audio). The versions, or streams, may also comprise one or more trick play or other specialty versions.

The content storage system may store the same portions of a lowest bitrate version or some other type of minimal playback version on a plurality of the storage subsystems to ensure that such a version having minimal playback quality may still be accessible in the event that one or more of the plurality of storage subsystems becomes unavailable or otherwise encounters a problem.

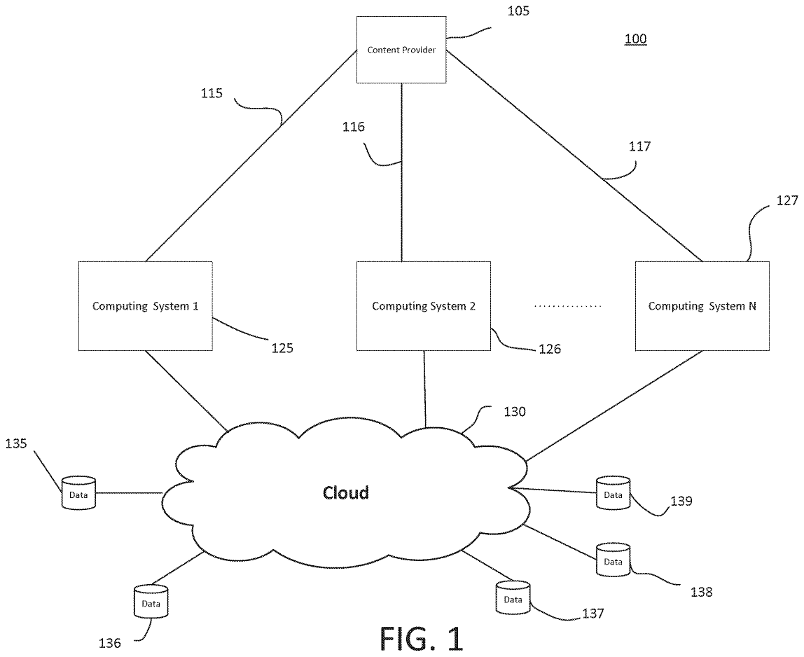

FIG. 1 shows an example system 100 configured to store multiple versions, or streams, of a content asset. The system 100 may comprise a content provider 105, one or more computing systems 125-127, and storage subsystems 135-139. Each of the computing systems 125-127 may be configured to manage the storage of content on the storage subsystems 135-139. Each of the computing systems 125-127 may, for example, comprise a recording system, such as an instance of a network digital video recorder (nDVR) or the like. The content provider 105 may provide a content asset to the computing systems 125-127. A content asset may comprise a television show, a movie, or some other form of content. The content provider 105 may be communicatively connected to each of the computing systems 125-127 via a communication path 115-117. Each communication path may comprise a wireless communication path, a fiber-optic or other form of wired communication path, or some form networked communications.

The computing systems 125-127 may receive the content asset from the content provider 105, generate one or more versions (e.g., streams) of the content asset and their respective segments, and store the segments of the streams to the storage subsystems 135-139. The computing systems 125-127 and storage subsystems 135-139 may be interconnected by a network 130. The network may comprise a WAN, a LAN, or any other type of network that may include at least a portion of the Internet.

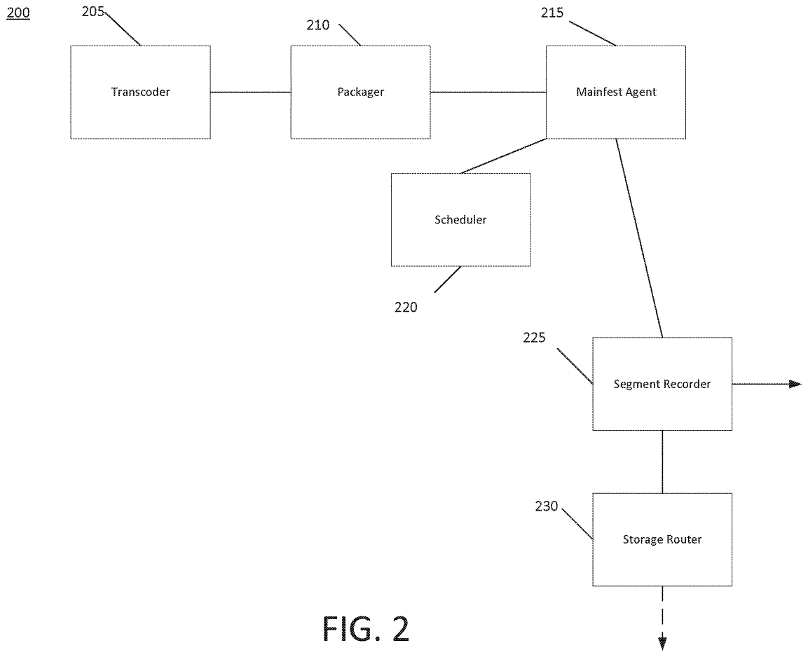

FIG. 2 shows an example computing system 200, such as any one of computing systems 125-127 shown in FIG. 1. The computing system 200 may comprise a transcoder 205, a packager 210, a manifest agent 215, a scheduler 220, a segment recorder 225, and a storage router 230. The transcoder 205 may receive a content asset from a content provider, such as the content provider 105 of FIG. 1. The transcoder may generate one or more streams, each of which may comprise a different version of the content asset. For example, each stream may comprise a version of the content asset encoded at a different bitrate. Other properties of a content asset that may differ among the streams include compression, resolution, frame rate, video quality (for video), number of channels, or sampling rate (for audio). The transcoder may also generate one or more trick play streams or other specialty streams for the content asset. The packager 210 may receive the one or more streams of the content asset from the transcoder 205 and may segment each of the one or more streams to produce, for each stream, a plurality of segments (i.e., portions) of the stream. The scheduler 220 may provide timing information for the segments of each of the streams, and the manifest agent 215 may generate a manifest for the content asset. The manifest may comprise a file containing information describing various aspects of the content asset that may be useful for a device to playback the content asset. The manifest may indicate the segments comprising each stream of the content asset, the length of each segment, the quantity of segments, and/or the proper ordering of the segments necessary to enable playback of the content asset. The manifest file may further comprise a network location (e.g., a hypertext transfer protocol (HTTP) uniform resource locater (URL) link or other universal resource identifier (URI)) for each segment from which the segment may be downloaded, accessed, or retrieved.

The segment recorder 225 may receive the segments from the packager 210, and timing information for each segment from the scheduler 220, and may store the segments to the storage subsystems of a content storage system, such as the storage subsystems 135-139 of FIG. 1. The storage router 230 may provide storage location information to the segment recorder 225 using a distribution algorithm as discussed below. Alternatively, the segment recorder 225 may provide the segment to the storage router 230, which may use the distribution algorithm to store the segment in the proper storage subsystem. The functionalities of the segment recorder 225 and the storage router 230 may be combined in a single component or element of the recorder system 200.

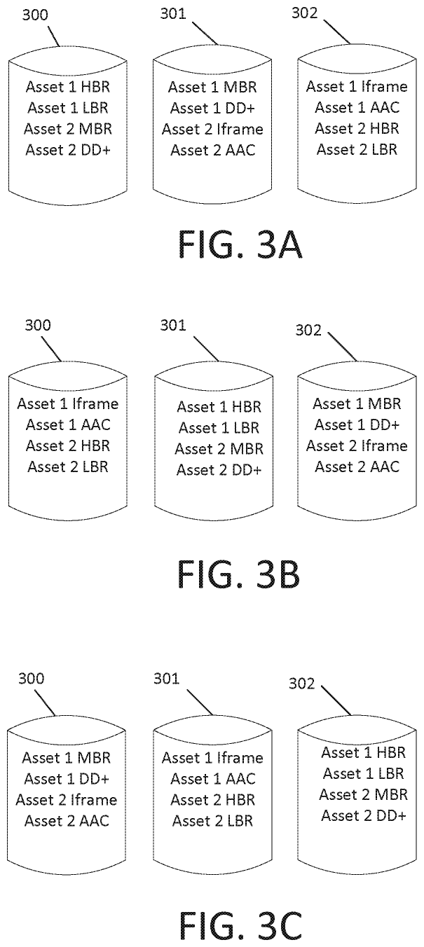

FIGS. 3A-3C illustrate one example of a method of storing portions of different versions (e.g., streams) of one or more content assets across a plurality of storage subsystems 300-302. The method may be performed, for example, by the segment recorder 225 and/or the storage router 230 of FIG. 2, or by any other suitable computing device. The portions to be stored may comprise one or more segments of the version of the content asset and may be received, for example, from a packager such as the packager 210 of FIG. 2. FIG. 3A illustrates the storage of portions of the different streams (i.e., versions) of a content asset across the storage subsystems 300-302.

In the example of FIG. 3A, portions of a plurality of streams of two different content assets—“Asset 1” and “Asset 2”—may be stored. The portions of the different streams depicted in FIG. 3A may be associated with a same time period (e.g., playback time) associated with the content asset. A portion (e.g., one or more segments) of a first stream of Asset 1 (e.g., the stream “Asset 1 HBR”), and a portion of a second stream of Asset 1 (e.g., the stream “Asset 1 LBR”), may be stored to the storage subsystem 300. The stream “Asset 1 HBR” may, for example, comprise a high bit rate (HBR) encoding of Asset 1, and the stream “Asset 1 LBR” may, for example, comprise a low bitrate encoding of the content Asset 1. As further shown, in this example, portions of two other streams of Asset 1-denoted as streams “Asset 1 MBR” and “Asset 1 DD+”—may be stored to the subsystem 301. And portions of two other streams of Asset 1-denoted as streams “Asset 1 Iframe” and “Asset 1 ACC”—may be stored to the subsystem 302. The stream “Asset 1 MBR” may, for example, comprise a medium bitrate encoding of the content asset. The streams “Asset 1 DD+,” “Asset 1 Iframe,” and “Asset 1 ACC” may comprise yet other different encodings of Asset 1. Similarly, portions of different streams of Asset 2 (e.g., the streams “Asset 2 HBR,” “Asset 2 LBR,” “Asset 2 MBR,” “Asset 2 DD+,” “Asset 2 Iframe,” and “Asset 2 ACC”) may be stored across the different subsystems 300-302 as shown.

FIG. 3B illustrates how the storage of subsequent portions of the various streams, associated with a second time period associated with the content asset, may change for that second time period. For example, as shown in FIG. 3B, subsequent portions of the streams Asset 1 Iframe and Asset 1 ACC, associated with the second time period, may be stored to the subsystem 300, subsequent portions of the streams Asset 1 HBR and Asset 1 LBR may be stored to the subsystem 301, and subsequent portions of the streams Asset 1 MBR and Asset 1 DD+ may be stored to the subsystem 302. As further illustrated, the storage of subsequent portions of the different streams of Asset 2 may be similarly changed for the second time period. As illustrated, the storage of the portions of the different streams may be shifted by one storage subsystem in a cyclical manner. The storage of portions may be shifted in a different manner. For example, the shifting may not be cyclical or the storage subsystems may be shifted by more than one of the storage subsystems of the cycle. Note that the portions of the various streams stored on subsystems 300-302 associated with the first time period, as illustrated in FIG. 3A, remain stored on those respective subsystems. That is, the change in the target subsystem for the portions of each stream applies only to the portions received from the packager 210 that are associated with the respective time period.

FIG. 3C illustrates how the continued storage of successive portions of the various streams may change again for a third time period associated with the content asset. For example, as shown in FIG. 3C, subsequent portions of streams Asset 1 MBR and Asset 1 DD+ associated with the third time period may be stored to the subsystem 300, portions of the streams Asset 1 Iframe and Asset 1 ACC may be stored to the subsystem 301, and portions of the streams Asset 1 HBR and Asset 1 LBR may be stored to the subsystem 302. The storage of subsequent portions of the different streams of Asset 2 may be similarly changed for the third time period. Again, the storage of portions of the different streams may be shifted by one storage subsystem in a cyclical manner. The storage of the portions may be shifted in a different manner.

The first, second, and third time periods represented in FIGS. 3A, 3B, and 3C, respectively, may be associated with at least one of a playback time or duration of a portion of the content asset, a recording time, or any other measure of time associated with the content asset. The first, second, and third time periods may comprise any suitable length of time. For example, the length of each time period may comprise, but is not limited to, 15 minutes (about one half or one quarter of a typical episode of a television program), 30 minutes (a whole or a half of a typical episode of a television program), one hour (a whole or two whole typical episodes of a television program), or two hours. The first, second, and third time period may have a fixed length. The first, second, and third time periods may have variable lengths.

As can be appreciated from the example of FIGS. 3A-3C, if one of the storage subsystems 300-302 suffers a catastrophic failure or otherwise becomes inaccessible, only the portion of a stream associated with a particular time period will become unavailable for playback on a user device; the portions associated with other time periods of the stream will be available on other ones of the storage subsystems. Also, portions of other streams of the content asset corresponding to the lost time period may be obtained from one of the other storage subsystems. Thus, in the event of a failure of one subsystem, the distribution of the portions of the streams across the plurality of storage subsystems enables a user device outputting a portion of one stream stored on that subsystem to obtain a corresponding portion from the next “best” stream stored on another storage subsystem. This may reduce the likelihood that a user will experience random playback failures when portions from a failed storage subsystem become unavailable.

The following is an example of playback based upon FIGS. 3A-3C. A user device may have enough network bandwidth available to receive portions of the highest quality stream of Asset 1, which in the example of FIGS. 3A-3C may be the stream “Asset 1 HBR”. The user device may therefore begin requesting and receiving portions of the Asset 1 HBR stream stored on storage subsystem 300. Between the beginning of the program and the end of the first time period, to, (for example 15 minutes), the storage subsystem 300 may experience a catastrophic failure and becomes unavailable. As such, the user device may no longer be able to retrieve portions of the Asset 1 HBR stream from that storage subsystem 300. The user device may switch to requesting portions of a different stream of the content asset Asset 1. For example, the user device may switch to requesting portions of the Asset 1 MBR stream stored on the storage subsystem 301. After the first time period expires and the second time period begins, the user device may again obtain portions from the Asset 1 HBR stream, because the portions of the Asset 1 HBR stream associated with the second time period are stored on the storage subsystem 301.

As this example illustrates, in the event of a catastrophic failure of a storage subsystem, playback of the content asset is not disrupted, because the portions of other streams of the content asset are available from other storage subsystems for the same playback time. This may allow a user device to obtain portions from another stream with parameters that still satisfy current network conditions. As such, a user consuming the content may only experience a mild downgrade in video quality due to the catastrophic failure of the storage subsystem 301. At the end of the playback time period in which the failure occurred, the user device may return to requesting and receiving portions of the stream previously lost due to the failure, because its portions for the subsequent time period are stored by another storage subsystem. Thus, even the degradation in video quality may be limited only to the time period in which the failure of the one subsystem occurred.

Another advantage of switching the storage of the portions of each stream to a different storage subsystem for each different time period is that the storage load of the streams can be evenly distributed across the various storage subsystems. For example, a higher bitrate stream may comprise a larger amount of data than a lower bitrate stream for the same playback time period of the content asset. Thus, by switching the storage of the portions of each stream to a different storage subsystem for every associated time period, the burden associated with storing the higher bitrate streams (i.e., the ones comprising the most data) may be more evenly distributed across the multiple subsystems. That is, the overall amount of data stored by each of the storage subsystems may be more evenly balanced.

As mentioned above, portions of a lowest quality stream of the content asset, such as the stream denoted Asset 1 LBR, may also be stored to more than one storage subsystem for each associated time period. This may ensure that a user device is able at least to retrieve portions from that lowest quality stream for any given time period, regardless of the number of storage subsystems that may have failed (as long as at least on storage subsystem remains available) and/or the current network conditions.

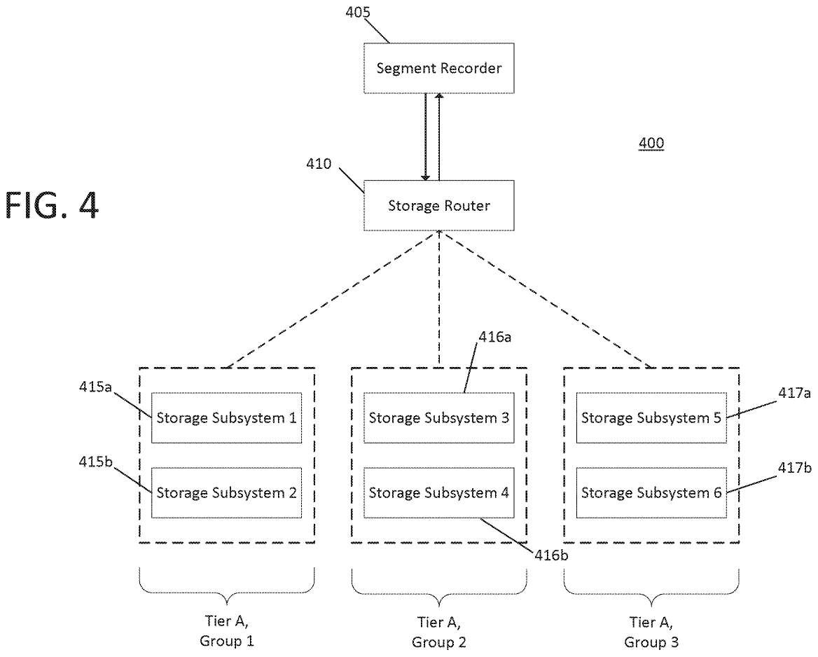

FIG. 4 shows another example system comprising a plurality of storage subsystems that may store portions of a plurality of different streams associated with a content asset. Each portion of a version of a content asset may comprise one or more segments of the version of the content asset. As shown, the system 400 may comprise a segment recorder 405, a storage router 410, and a plurality of storage subsystems 415a, 415b, 416a, 416b, 417a, 417b. The segment recorder 405 may receive portions of each of the plurality of different streams of the content asset. For example, the segment recorder 405 may receive the portions of the different streams from a packager, such as the packager 210 of FIG. 2. For each received portion, the segment recorder 405 may generate a storage request and send the storage request to the storage router 410. As discussed above, although the segment recorder 405 and the storage router may comprise separate components of the system 400 as shown in FIG. 4, the functionality of the segment recorder 405 and the storage router 410 may be implemented in a single computing device or component. Each storage request may comprise one or more of a user identifier that identifies the user associated with the content asset of which the portion is being stored, a profile of the stream of which the portion is a part, which profile may comprise an identifier of the stream and/or a parameter associated with the stream, and/or a channel type that identifies a type associated with the stream.

The storage router 410 may receive the request and, based on the information in the request, determine a storage subsystem in which to store the portion of the stream. The storage router 410 may use a distribution algorithm to determine which of the plurality of storage subsystems in which to store the portion. In determining in which storage subsystem the portion is to be stored, the storage router 410 may access configuration information from a configuration file, a library, or any other suitable data structure that comprises information indicative of a grouping of the plurality of storage subsystems into one or more groups and tiers, as well as associating users with the one or more groups or tiers. Such use of a configuration file or library may allow multiple storage routers associated with different systems to make the same determination with respect to storage groups and tiers when storing segments of the same content asset in a synchronized manner. In that scenario, the storage routers may synchronize based on a same universal time.

One or more of the plurality of storage subsystems of a content storage system may be logically grouped together. Such a grouping may be referred to as a tier. The plurality of storage subsystems may be grouped into a plurality of different tiers. FIG. 4 illustrates one example tier-“Tier A.”

The one or more subsystems in a tier may be further grouped together based on operational parameters of the subsystems. Each such further grouping may be referred to herein as a “group” within the tier and may comprise a subset of the storage subsystems of the tier. In the example of FIG. 4, Tier A comprises three groups-Group 1, Group 2, and Group 3. Tier A, Group 1 comprises storage subsystems 1 and 2, Tier A Group 2 comprises storage subsystems 3 and 4, and Tier A Group 3 comprises storage subsystems 5 and 6.

The system may select one particular tier to store the various streams (i.e., versions) of a particular content asset. Selection of the tier in which to store the streams of a particular content asset may be based on a quality of service associated with a user requesting that the content asset be stored. For example, a user may have a subscription for a higher quality of service that dictates that storage subsystems that are more reliable and more able to quickly process requests are used for storage of content assets for the user. Alternatively, the selection of the tier may be based on the content asset being stored. For example, a popular show that is in an HD or UltraHD format may be best stored in a tier with faster or larger storage capacities. Programs in a SD format or some other format may be stored to other tiers or groups that may operate at slower speeds.

To promote even distribution of content across the storage subsystems, a lesser number of tiers may be preferred, with each tier comprising a greater number of storage subsystems. For example, a larger number of tiers may cause recordings of a popular content asset, such as a popular episode of a television program, to be stored on only a small percentage of the storage subsystems available, whereas with a smaller number of tiers, the same content asset may be stored across a greater percentage of the storage subsystems available.

Different streams of a content asset may be stored to the storage subsystems of different groups of a tier. Determining which streams of a content asset are to be stored in which groups of a tier may be based on reliability considerations. For example, because the loss of a medium bitrate (MBR) stream due to storage subsystem failure may result in a playback device switching to a low bitrate (LBR) stream, it may be preferable to store MBR streams of a content asset to the storage subsystems of one group and to store low bitrate (LBR) streams of the content asset to the storage subsystems of a different group of the tier.

Determining which streams of a content asset are to be stored in which groups of a tier may be based on storage size considerations. For example, it may be preferable to store the different streams in different groups such that the aggregate size of each group is close to all other groups. This may result in more even writes across tier groups for any given content asset.

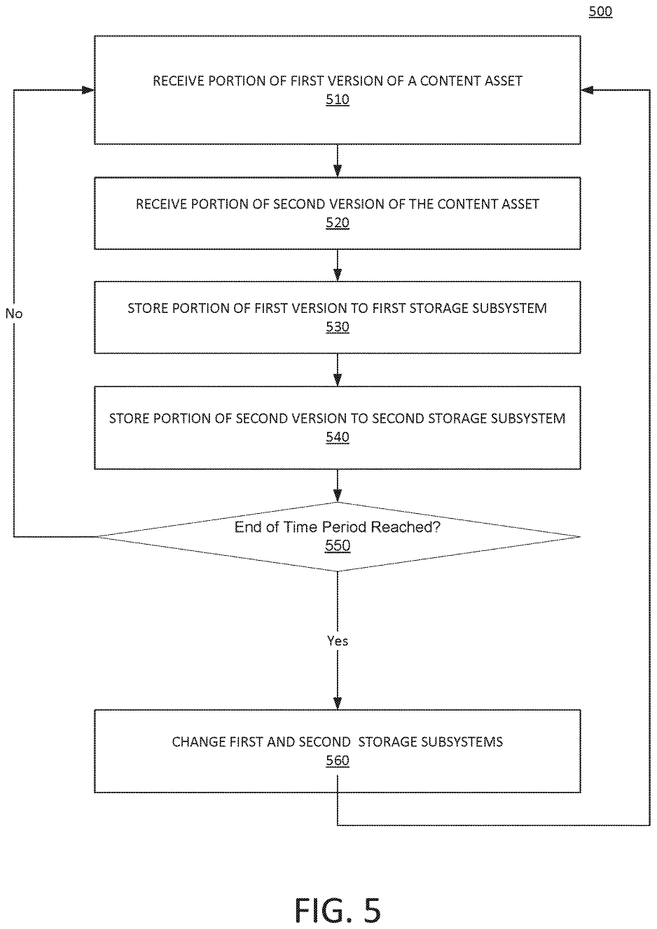

FIG. 5 illustrates one example of a method 500 that may be performed by a content storage system. The system may receive a portion of a first version of a plurality of different versions of a content asset in step 510. The portion of the first version may comprise one or more segments of the first version of the content asset. Each of the plurality of different versions of the content asset may comprise a stream of segments associated with that version of the content asset. Each of the plurality of different versions of the content asset may comprise a version of the content asset encoded at a different bitrate. Other properties of a content asset that may differ among the versions include compression, resolution, frame rate, video quality (for video), number of channels, or sampling rate (for audio). The versions may also comprise one or more trick play or other specialty versions.

In step 520, the system may receive a portion of a second version of the content asset. Similar to the portion of the first version of the content asset, the portion of the second version of the content asset may comprise one or more segments of the second version of the content asset. The portions of the first and second versions of the content asset may comprise one or more segments associated with a same time period associated with the content asset, such as a portion of the playback time of the content asset. In step 530, the system may store the portion of the first version of the content asset in a first storage subsystem of a plurality of storage subsystems of the content storage system. In step 540, the system may store the portion of the second version of the content asset in a second storage subsystem of the plurality of storage subsystems. The first and second storage subsystems may be different storage subsystems to ensure that content is available from at least one of the versions (e.g., streams) of the content asset in the event of a catastrophic failure of one or more of the storage subsystems.

In step 550, the system may determine whether the end of a first time period associated with the content asset has been reached. The first time period may comprise at least one of a playback time associated with the content asset, a recording time associated with the content asset, an absolute time, a relative time, or another measure of time associated with the content asset. The time period may comprise any suitable length of time. For example, the length of the time period may comprise, but is not limited to, 15 minutes (about one half or one quarter of a typical episode of a television program), 30 minutes (a whole or a half of a typical episode of a television program), one hour (a whole or two whole typical episodes of a television program), or two hours. The time period may have a fixed length. The time period may have a variable length.

If the end of the time period has not been reached in step 550, the method may be repeated from step 510 using the same first and second storage subsystems. That is, subsequently received portions of the first and second versions of the content asset associated with the current time period may continue to be stored to the first and second storage subsystems, respectively.

If the end of the time period has been reached at step 550, the first and second storage subsystem may be changed to other storage subsystems at step 560, such that subsequently received portions of the first and second versions of the content asset, associated with a next time period associated with the content asset, are stored to different storage subsystems. As illustrated in FIGS. 3A-C, the storage of the portions of the different versions of the content asset associated with the next time period may be shifted by one storage subsystem, of the plurality of storage subsystems, in a cyclical manner. The storage of portions of the different versions may be shifted in a different manner. Note that the portions of the first and second versions of the content asset associated with the first time period, which were stored to the first and second storage, remain stored on those respective first and second storage subsystems. That is, the change, at step 560, in the target subsystems for portions of the first and second versions of the content asset associated with the next time period applies only to portions received from the packager that are associated with that next time period.

In accordance with the method 500 illustrated in FIG. 5, if one of the plurality of storage subsystems suffers a catastrophic failure or otherwise becomes inaccessible, only portions of a version of the content asset associated with a particular time period will become unavailable for playback on a user device; the portions associated with other time periods of that version will be available on other ones of the storage subsystems. Also, portions of other versions of the content asset corresponding to the lost time period can be obtained from another of the subsystems. Thus, in the event of a failure of one subsystem, the distribution of the portions of the different versions across the plurality of storage subsystems enables a user device outputting the portions of one version stored on that subsystem to obtain corresponding portions from a different version. The selection of a different version, or stream, from which to obtain the corresponding portions may be based on current network conditions. This reduces the likelihood that a user will experience random playback failures when portions of a content asset from a failed storage subsystem become unavailable.

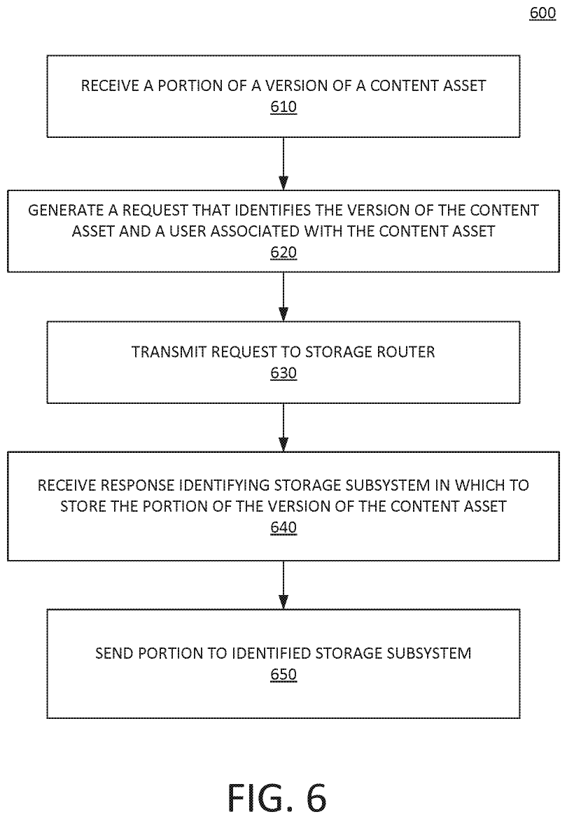

FIG. 6 illustrates another method 600 which may be performed, for example, by the segment recorder 225 of FIG. 2 or the segment recorder 405 of FIG. 4. In step 610, a portion of a version of a content asset may be received. The portion may comprise one or more segments of the version of the content asset. A request for storage information may be generated in step 620. As discussed above, the request for storage information may include a user identifier that identifies the user associated with the content asset being stored, and a profile associated with the version of the content asset that identifies the version and/or parameters associated with the version of the content asset.

In step 630, the request for storage information may be transmitted to a storage router. The storage router may be configured to implement a storage distribution algorithm such as that described above and illustrated in FIGS. 3A-C and/or FIG. 5. In step 640, a response may be received from the storage router identifying a storage subsystem in which the portion of the version of the content asset is to be stored. In step 650, the segment recorder may send the portion of the version of the content asset to the identified storage subsystem. For example, the segment recorder may send a PUT command to the storage subsystem to cause the portion to be stored by the identified storage subsystem.

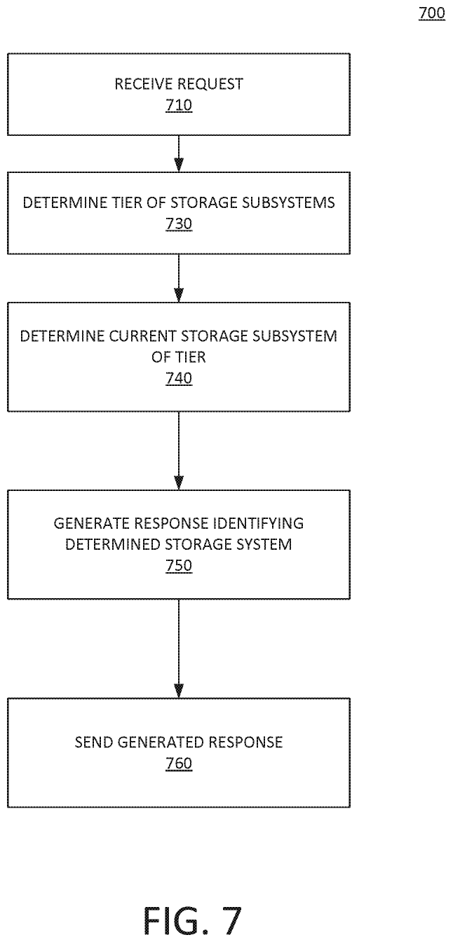

FIG. 7 illustrates a method that may be performed by a storage router to determine a storage subsystem that is to store a portion of a version of a content asset. A request for storage information for a portion of a version of a content asset may be received in step 710. The request for storage information may be received from a segment recorder, such as the segment recorder 225 or the segment recorder 405. As discussed above, the request for storage information may include a user identifier that identifies the user associated with the content asset being stored, and a profile associated with the version of the content asset that identifies the version and/or parameters associated with the version.

In step 730, the storage router may determine a tier of storage subsystems in which to store the portion of the version of the content asset. The determination may be based on a look-up table, a configuration file, or a designation in the received request. The determination may be based on the user identification and/or the profile associated with the version of the content asset.

In step 740, the storage router may determine a current storage subsystem, or one or more storage subsystems, of the tier in which to store the portion of the version of the content asset. The storage router may determine the current storage subsystem based on a method such as that described above and illustrated in FIGS. 3A-C and/or FIG. 5. The determination may be based on one or more parameters associated with the version of the content asset to which the portion belongs, a current time period as determined by a time maintained by a clock associated with the storage router, and/or a designation in a configuration file or library.

In step 750, a response message may be generated that identifies the current storage subsystem in which the portion of the version of the content asset is to be stored. In step 760, the response message may be sent to the segment recorder from which the request for storage information was received.

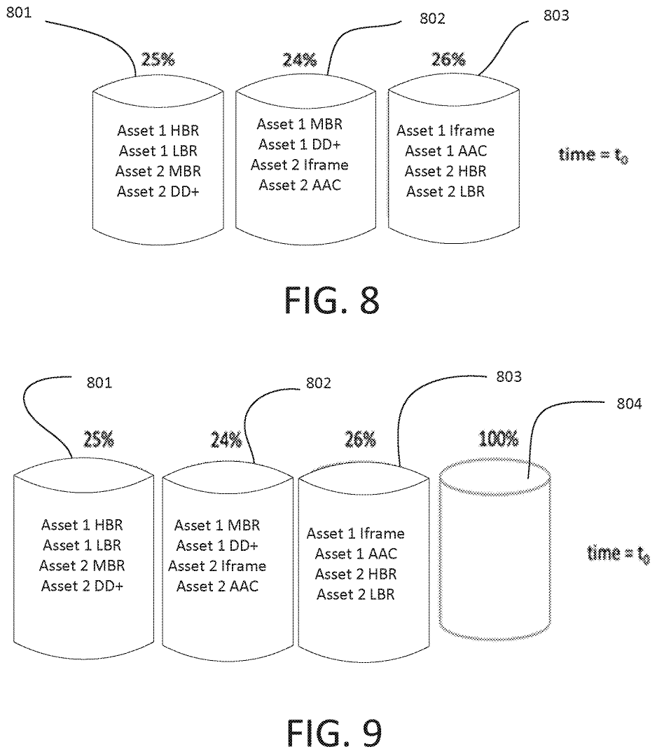

As discussed above, a distribution algorithm, such as that described above and illustrated in FIGS. 3A-C and/or FIG. 5, may be used to determine in which of the storage subsystems of a tier to store a portion of a version of a content asset associated with a current time period. While the successive time periods used to store the different versions of a content asset may be time periods having a fixed length, as described above and illustrated in FIGS. 3A-C and FIG. 5, a capacity adaptive algorithm may be used to determine a variable length of each time period for storing portions of a particular version (or group of versions) of a content asset to a particular storage subsystem. Such a capacity adaptive algorithm is described with reference to FIGS. 8-15. The capacity adaptive algorithm also may provide load balancing for a tier, or group within a tier, of storage subsystems, particularly in the event of the introduction of new storage subsystems into to the group or tier.

In accordance with the capacity adaptive algorithm, a weighting or ratio, such as a multiplier, may be added to an initial calculation and subsequent calculations of a length of time for storing portions of a particular version (or group of versions) of a content asset to be written to a particular storage subsystem in a tier. The weighting may comprise a weighting multiplier based upon a current available (i.e., free) storage capacity of each storage subsystem. The weighting multiplier may be adjusted for every successive time period. The value of the weighting multiplier may be changed each time the calculation is performed to account for changes to the available storage capacity of the storage subsystems as portions of the versions of the content asset are stored in the subsystems. The capacity adaptive algorithm may only be used when a number of storage subsystems in a tier or group is greater than a number of versions of a content asset being stored, as expressed in the following equation:

$$S > C$$

where S represents the number of storage subsystems available in the tier and C represents the number of versions of a content asset being written to the storage subsystems. If the number of storage subsystems is less than or equal to the number of versions of the content asset, the distribution algorithm described above and illustrated in FIGS. 3A-C and FIG. 5 may be employed with fixed length time periods.

FIG. 8-12 illustrate the determination of time periods in accordance with the capacity adaptive algorithm. FIG. 8 illustrates three storage subsystems 801, 802, and 803, each storing portions of a plurality of versions of two different content assets (shown as “Asset 1” and “Asset 2”). For example, the storage subsystem 801 stores portions of versions “HBR” and “LBR” of Asset 1 and portions of versions “MBR” and “DD+” of Asset 2. The storage subsystem 802 stores portions of versions “MBR” and “DD+” of Asset 1 and portions of versions “Iframe” and “AAC” of Asset 2. The storage subsystem 803 stores portions of versions “Iframe” and “AAC” of Asset 1 and portions of versions “HBR” and “LBR” of Asset 2.

By way of example and not limitation, assume that the portions of the different versions of Asset 1 and Asset 2 have been stored to the storage subsystems 801, 802, and 803 in accordance with the distribution algorithm described above and illustrated in FIGS. 3A-C and FIG. 5 from a time t₀, with a fixed time period of m used as the interval for changing storage subsystems. Assume further that n represents the number of times the system has shifted up to the current time period illustrated in FIG. 8. The start of the current time period can be represented as: time=t0+(m*n), and the start of the next time period (i.e., shift interval) can be calculated as time=t0+(m*(n+1)).

After the system has operated for some period of time, a substantial portion of the available capacity of the currently available storage subsystems is currently being used. As shown in FIG. 8, each storage subsystem has a remaining capacity available, represented by the percentage number above each subsystem. For example, subsystem 801 has 25% capacity remaining, and subsystem 802 has 24% remaining capacity. As the system has operated consistently over time and in an orchestrated fashion, the storage capacity of partitions 801-803 are relatively balanced and may be described as being in a state of near equilibrium.

At some later point in time, assume further that the available capacity of the storage subsystems 801-803 may be insufficient to support the additional content expected or anticipated over some future time period. To meet the future demand, a new storage subsystem 804 may be added to the system. The storage subsystem 804 may have a nearly 100% available capacity while the existing subsystems 801-803 have on average about 25% available capacity.

In this situation, when a fixed time period, such as the time period of fixed length m, is used in the distribution algorithm, several scenarios are likely to occur:
1) the original set of subsystems may exhaust their capacity and may be unable to store additional portions of the content asset(s), resulting in the system storing more and more of the content onto the same subsystem;
2) underutilization of the available storage capacity may occur until the majority of content on the original set of subsystems is eventually removed, for example due to aging; or
3) a new service may need to be created to redistribute (e.g., copy) at least some of the existing content to the new available storage in the new storage subsystem to again achieve a near equilibrium state across all the storage subsystems. Each of these scenarios may be undesirable.

To avoid these potential scenarios, the capacity adaptive algorithm changes the formula for a time period duration from:

$$time = t 0 + ( m * n )$$

where m represents the fixed shift interval and n represents the number of consecutive preceding time periods, to a new formula:

$$time = t 0 + ( m * f ( x ) )$$

where f(x) represents a function that is a weighting or ratio applied based upon a proportion of the available capacity of the individual storage subsystems and time is the start time of the next time period.

The function represented by f(x) can be implemented by a variety of formulas. Some examples that may be employed include, but are not limited to, a logistic function, an error function, or a tanh function. The results produced by f(x) might change for different numbers of simultaneous storage subsystems actively being used to store content at a particular instant in time.

The function f(x) preferable complies with the two requirements:
(1) portions of two or more versions of a content asset associated with a same time period, which a playback device may switch between in the event of a failure of a storage subsystem storing the portions of one of the versions, should not be stored on the same storage subsystem; and
(2) a hashing function should be used to determine a first storage subsystem on which to begin storing portions of a version (or grouping of versions) of a content asset.

For purposes of illustrating the capacity adaptive algorithm, assume an example system comprising four (4) storage subsystems, denoted S₀, S₁, S₂, and S₃, three (3) versions (or groups of versions) of a content asset to be stored, and a value of 10 minutes for m.

Assume further a simple mathematical computation for the function f(x), which utilizes the available capacity of each storage subsystem. The function produces a duration of time to store each version of the content asset to the particular storage subsystem and is represented by:

$$f ( x ) = 2 * capacity of the storage subsystem as a percentage .$$

Using this formula, x would vary from 0 to 2 times the value of m from the fixed interval distribution algorithm described above and illustrated in FIGS. 3A-C and FIG. 5. The function f(x) may be applied to each storage subsystem individually, varying the durations of the time periods for each storage subsystem. Therefore, the duration, d, for a specific storage subsystem, Sᵢ, may be calculated by (m*2*capacity of the storage subsystem).

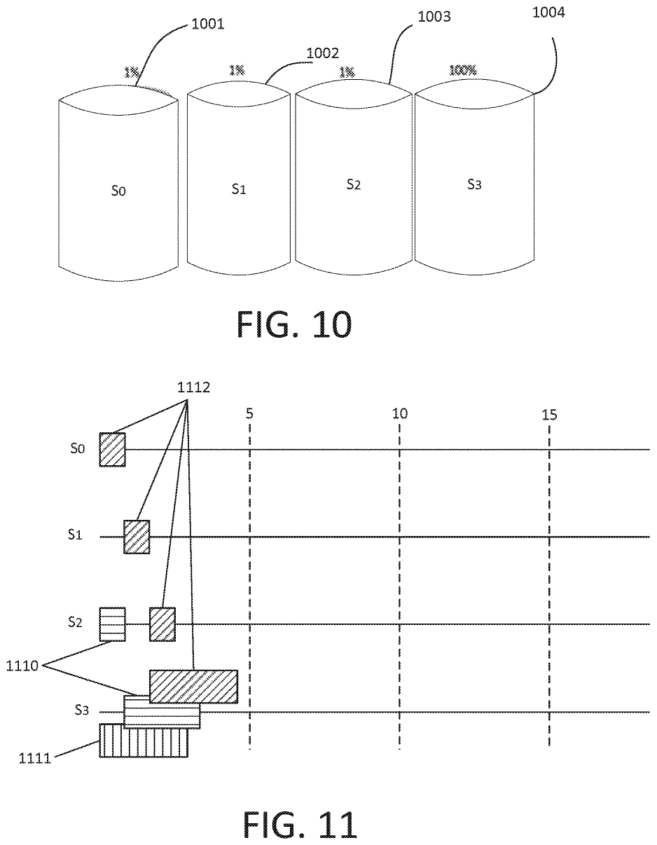

The use of the above function, f(x), without any further processing on the resulting durations, may result in violating at least one of the above requirements (i.e., portions of different versions of a content asset that a playback device may switch between in the event of a storage subsystem failure should not be stored on a same storage subsystem, and the first storage system on which to begin storing portions of a version of the content asset should be determined using a hashing function). For example, with reference to FIG. 10, assume a system comprising four storage subsystems S₀, S₁, S₂, and S₃, each having an available capacity shown by the percentage above each storage subsystem.

Using the function f(x) to calculate the duration of the time period for each storage subsystem produces the following results:

$${d}_{0} ( 10 * 2 * \text{.01} ) = 0.2 min ;$$

$${d}_{1} ( 10 * 2 * \text{.01} ) = 0.2 min ;$$

$${d}_{2} ( 10 * 2 * \text{.01} ) = 0.2 min ; and$$

$${d}_{3} ( 10 * 2 * 1 ) = 20 min .$$

In this example, within 0.6 mins regardless of which storage subsystem is selected to begin the storing of a version (or group of versions) of the content asset, multiple versions of the content asset will be written to a same one of the storage subsystems. To prevent this from occurring, a constraint may be enforced that the duration of each time period must be less than or equal to the sum of all durations of the time periods for each storage subsystem. This constraint can be expressed by the following equation:

$${d}_{i} \leq {\sum }_{s = 0}^{n} {d}_{s} - {d}_{i}$$

where d₀ through dₙ represents the individual weight adjusted duration calculations of all d for each storage subsystem; and dᵢ is the weighting of a specific weight adjusted capacity calculation, which may be referred to herein as the normalization constraint. When applying the normalization constraint to the duration calculations above, d₃ (storage subsystem S₃) is reduced to the sum of the other three durations as shown in the following:

$${d}_{0} ( 10 * 2 * \text{.01} ) = 0.2 min . ;$$

$${d}_{1} ( 10 * 2 * \text{.01} ) = 0.2 min . ;$$

$${d}_{2} ( 10 * 2 * \text{.01} ) = 0.2 min . ; and$$

$${d}_{3} ( 10 * 2 * 1 ) = 20 min > 0.2 + 0.2 + 0.2 ;$$

$$reduce to 0.2 + 0.2 + 0.2 = 0.6 min .$$

However, even with the application of the normalization constraint, the maximum amount of time that a particular version (or group of versions) of a content asset may be stored before needing to be stored on d₃ (subsystem S₃) is 0.4 min, but the first version being written on that storage subsystem would be written for 0.6 min. This would result in a violation of the first requirement. Thus, to overcome this issue a duration for the time period of any specific subsystem must not exceed a maximum value-referred to herein as a maximum constraint. This constraint may be calculated by first performing an ascending sort on the set of calculated durations represented by D:

$$D = ascending sort \{ {d}_{0} , {d}_{1} , {d}_{2} , {d}_{3} \} = \{ 0.2 , 0.2 , 0.2 , 0.6 \}$$

Next, the first n entries from D may be summed and divided by n−1 (because each version must be written to a different storage subsystem at any given point), where n is the number of versions of the content asset to store to the system and m is the resulting maximum constraint value.

$$m = \frac{( {\sum }_{i = 0}^{n} {d}_{i} )}{( n - 1 )}$$

When calculating the maximum constraint value for the current example, the result of m is 0.3 min. After applying the normalization and maximum constraints, the calculated durations are:

$${d}_{0} = 0.2 min . ;$$

$${d}_{1} = 0.2 min . ;$$

$${d}_{2} = 0.2 min . ; and$$

$${d}_{3} = 0.2 min .$$

However, there is a third issue that can arise from the combination of the first and second requirements. With reference to FIG. 11, if d₂ (subsystem S₂) is selected to store portions of a first version of a content asset when commencing a recording of the content asset, the resulting timelines for each storage subsystem S₀, S₁, S₂, and S₃ may be as shown in FIG. 11. In FIG. 11, the bars 1110 represent portions of the first version of the content asset, denoted g₁, the bar 1111 represents a portion of a second version of the content asset, denoted g₂, and the bar 1112 represent portions of a third version of the content asset, denoted g₃.

As shown, the portions of the first, second and third versions overlap on storage subsystem S₃, which violates the first requirement (two different versions of the content asset associated with a same playback time cannot be stored by the same storage subsystem). Therefore, an additional constraint, referred to herein as a jitter constraint, may be imposed to prevent two or more versions of the content asset from being stored to the same storage subsystem. This jitter constraint may require that the initial duration of a time period be greater than or equal to the duration of the number of versions minus one of the other determined time periods. This can be represented by the equation:

$${d}_{i} = maximum \{ da , {d}_{a} + 1 , … , {d}_{n} - 1 \}$$

where dᵢ is a maximum weighting from a set of specific weight adjusted durations from the subsequent group of durations. Applying the jitter constraint, and using the previously computed time periods after the normalization and maximum constraints, results in the following first time periods for the storage systems:

g₁ = maximum of (0.2, 0.3 or 0.2) from the d₂, d₃ and d₀ subsystems = 0.3 min. on S2;
g₂ = maximum of (0.3 or 0.2 min.) from the d₃ and d₀ subsystems = 0.3 min. on S3;
and
g₃ = 0.2 as there are no more values to compare because n − 1 = zero remaining
versions.

All subsequent writes may continue using the computed values produced by the individual durations of the time periods after applying the normalization and maximum constraints.

A final constraint may be to not store any partial segments of a content asset to a storage subsystem. Thus, if the weighted value of dᵢ is not evenly divisible by the segment duration, dᵢ may be rounded down to the nearest full-time duration. For example, in the case of 2 second segments, the write time for a storage subsystem could be up to 2 seconds less than the weighted duration calculates for a single subsystem but ensures the fulfillment of the first requirement.

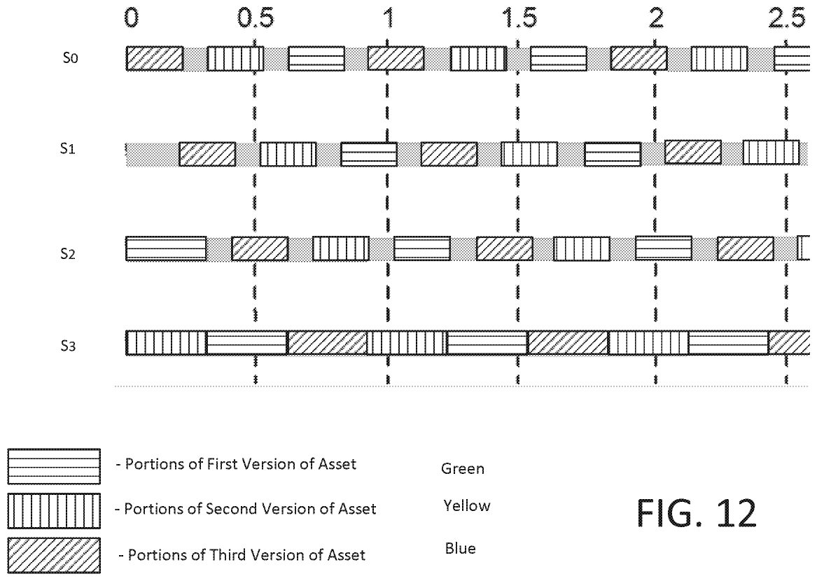

In this described example, assume that all of the time period durations are fully divisible by the segment time interval (e.g., 2 seconds). This results in the timeline shown in FIG. 12 for storing portions of the three different versions of the content asset. The illustrated pattern demonstrates that the capacity adaptive algorithm achieves the first and second requirements.

Note that the initial duration for the portions of the first version of the content asset on storage subsystem S2 is the same as for the initial duration of the second version of the content asset on storage system S3. This is due to the jitter constraint calculation. Also, the gray intervals in between the stored portions represent periods of time when there is no active version of the content asset being written to the corresponding storage subsystem. Lastly, viewing the timeline of storage subsystem S₃ shows no periods with inactivity. This illustrates the capacity adaptive algorithm's maximization of the storage subsystem with the greatest free capacity.

The capacity adaptive algorithm may be reapplied to determine the time periods for each of the subsystems storing versions of the content asset. The capacity adaptive algorithm may be used to recalculate the duration of the current time period based on the remaining free capacity. The likelihood of a particular versions (or group of versions) of a content asset being stored too often to the same partition may be further reduced by randomly distributing the order of the versions allocated to the function. For example, one or more HBR versions might be assigned as g₁ for one requested calculation, but then may get assigned to g₂ on the next requested calculation of the capacity adaptive algorithm.

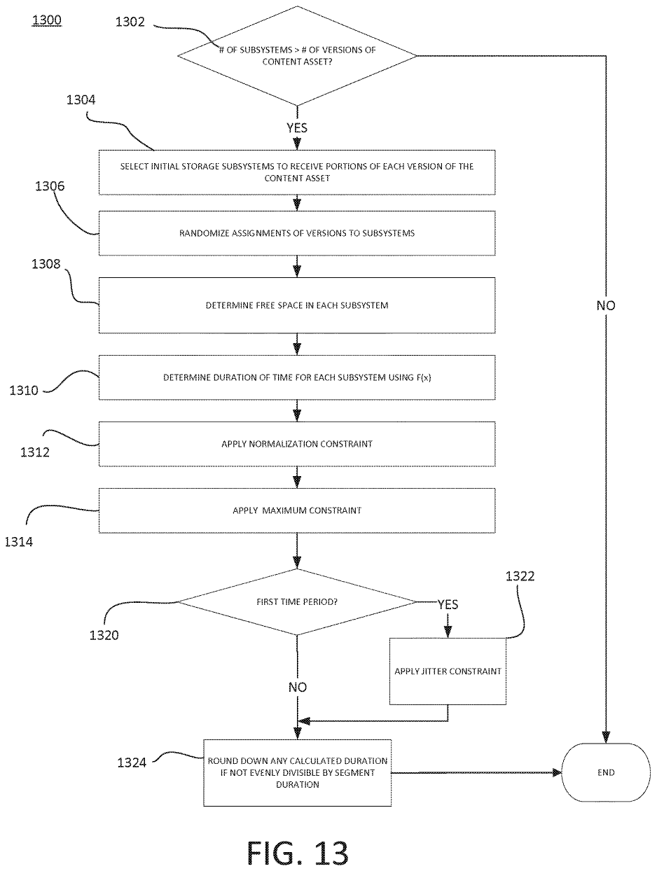

FIG. 13 illustrates a method 1300 for performing the capacity adaptive algorithm described above. The method may be performed, for example, each time the storage router recomputes which storage subsystems are to store each of the versions of a content asset. In step 1302, a determination is made whether the number of storage subsystems is greater than the number of versions (or groups of versions) of a content asset being stored. If so, in step 1304, a hash function may be employed to select an initial storage subsystem to store the first portions of each version or group of versions of the content asset. Optionally, the assignment of the version(s) and/or group(s) of versions to storage subsystems may be randomized in step 1306.

A percentage of available (i.e., free) space on each storage subsystem may be determined in step 1308. The duration of the time period for each subsystem to store portions of a particular version or group of versions may be determined in step 1310. This determination may be made using the function f(x) described above. In step 1312, the normalization constraint may be applied to the determined durations. In step 1314, the maximum constraint may be applied.

In step 1320, if it is determined that the current time period is the initial time period for storing versions of the content asset, the jitter constraint may be applied in step 1322. Application of the jitter constraint in step 1322 may be optional. Application of the jitter constraint may not be limited to the initial time period; the jitter constraint may be applied in association with other time periods. In step 1324, any determined duration that is not evenly divisible by the segment duration (e.g., 2 seconds) may be rounded down so that is evenly divisible.

In situations where a storage subsystem fails, becomes exhausted, or is taken offline for maintenance, the capacity adaptive algorithm described above may easily adapt to the reduction of available subsystems. An automated detection of the loss of a storage subsystem may be used to trigger the invocation of the algorithm to redistribute the load across the remaining available subsystems.

The capacity adaptive algorithm may also be advantageous when content assets, or certain streams of a content asset, are migrated to a Capped Variable Bit Rate (CVBR) stream. For example, when migrated to CVBR, the size of a high bit rate (HBR) stream associated with one content asset may be substantially different than the HBR stream of a different content asset, based upon the complexity of the underlying video content, resulting in varying storage utilization by content asset. By adapting to the current available free capacity over some time period using the capacity adaptive algorithm, the system may adapt to the preceding time period's writing sizes allowing the overall system to achieve equilibrium sooner and remain there for longer periods of time.

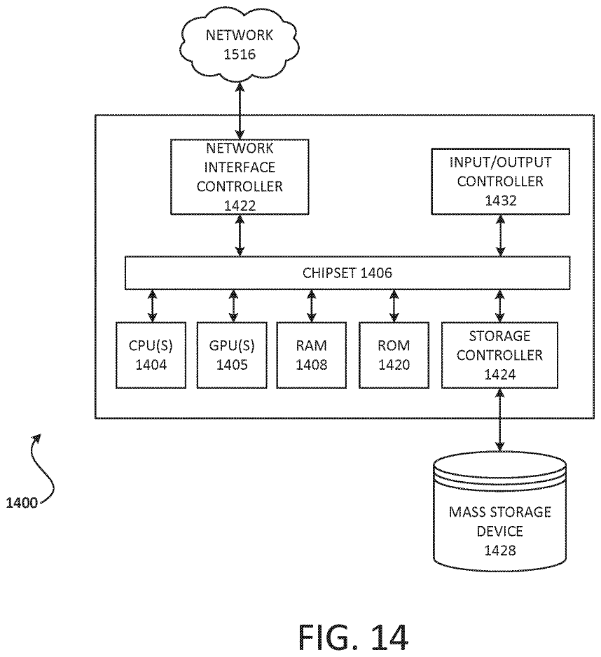

FIG. 14 depicts a computing device 1400 that may be used to implement any of the computing systems, servers, modules, components, devices, storage subsystems, or other apparatus depicted in FIG. 1, 2, 3A-C, 4, 8, 9, or 10. The computing device shown in FIG. 14 may comprise a server, computer, workstation, desktop computer, laptop, tablet, network appliance, PDA, e-reader, digital cellular phone, or other computing node or device, and may be utilized to execute any aspects of the methods described herein, such as the methods described and illustrated in relation to FIGS. 3A-C, 5-7, and 8-10.

The computing device 1400 may include a baseboard, or “motherboard,” which is a printed circuit board to which a multitude of components or devices may be connected by way of a system bus or other electrical communication paths. One or more central processing units (CPUs) 1404 may operate in conjunction with a chipset 1406. The CPU(s) 1404 may be standard programmable processors that perform arithmetic and logical operations necessary for the operation of the computing device 1400.

The CPU(s) 1404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1404 may be augmented with or replaced by other processing units, such as GPU(s) 1405. The GPU(s) 1405 may comprise processing units specialized for but not necessarily limited to highly parallel computations, such as graphics and other visualization-related processing.

A chipset 1406 may provide an interface between the CPU(s) 1404 and the remainder of the components and devices on the baseboard. The chipset 1406 may provide an interface to a random access memory (RAM) 1408 used as the main memory in the computing device 1400. The chipset 1406 may further provide an interface to a computer-readable storage medium, such as a read-only memory (ROM) 1420 or non-volatile RAM (NVRAM) (not shown), for storing basic routines that may help to start up the computing device 1400 and to transfer information between the various components and devices. ROM 1420 or NVRAM may also store other software components necessary for the operation of the computing device 1400.

The computing device 1400 may operate in a networked environment using logical connections to remote computing nodes and computer systems through local area network (LAN) 1416. The chipset 1406 may include functionality for providing network connectivity through a network interface controller (NIC) 1422, such as a gigabit Ethernet adapter. A NIC 1422 may be capable of connecting the computing device 1400 to other computing nodes over a network 1416. It should be appreciated that multiple NICs 1422 may be present in the computing device 1400, connecting the computing device to other types of networks and remote computer systems.

The computing device 1400 may be connected to a mass storage device 1428 that provides non-volatile storage for the computer. The mass storage device 1428 may store system programs, application programs, other program modules, and data, which have been described in greater detail herein. The mass storage device 1428 may be connected to the computing device 1400 through a storage controller 1424 connected to the chipset 1406. The mass storage device 1428 may consist of one or more physical storage units. A storage controller 1424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1400 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1428 is characterized as primary or secondary storage and the like.

For example, the computing device 1400 may store information to the mass storage device 1428 by issuing instructions through a storage controller 1424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1400 may further read information from the mass storage device 1428 by detecting the physical states or characteristics of one or more particular locations within the physical storage units.

In addition to the mass storage device 1428 described herein, the computing device 1400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1428 depicted in FIG. 14, may store an operating system utilized to control the operation of the computing device 1400. The operating system may comprise a version of the LINUX operating system. The operating system may comprise a version of the WINDOWS SERVER operating system from the MICROSOFT Corporation. The operating system may comprise a version of the UNIX operating system. Various mobile phone operating systems, such as IOS and ANDROID, may also be utilized. It should be appreciated that other operating systems may also be utilized. The mass storage device 1428 may store other system or application programs and data utilized by the computing device 1400.

The mass storage device 1428 or other computer-readable storage media may also be encoded with computer-executable instructions, which, when loaded into the computing device 1400, transforms the computing device from a general-purpose computing system into a special-purpose computer capable of implementing the methods or apparatus described herein. These computer-executable instructions transform the computing device 1400 by specifying how the CPU(s) 1404 transition between states, as described herein. The computing device 800 may have access to computer-readable storage media storing computer-executable instructions, which, when executed by the computing device 1400, may perform the methods described in relation to FIGS. 5 and 6.

A computing device, such as the computing device 1400 depicted in FIG. 14, may also include an input/output controller 1432 for receiving and processing input from a number of input devices, such as a keyboard, a mouse, a touchpad, a touch screen, an electronic stylus, or other type of input device. Similarly, an input/output controller 1432 may provide output to a display, such as a computer monitor, a flat-panel display, a digital projector, a printer, a plotter, or other type of output device. It will be appreciated that the computing device 1400 may not include all of the components shown in FIG. 14, may include other components that are not explicitly shown in FIG. 14, or may utilize an architecture completely different than that shown in FIG. 14.

As described herein, a computing device may be a physical computing device, such as the computing device 1400 of FIG. 14. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
during a first time period, storing portions of each of a plurality of differently encoded versions of a content asset on different ones of a plurality of storage subsystems, wherein the plurality of storage subsystems forms a circular sequence of storage subsystems; and
repeatedly, at the start of each of a plurality of subsequent time periods, changing the storage subsystems on which portions of each of the plurality of differently encoded versions of the content asset are stored by shifting the storing of portions of each of the plurality of differently encoded versions of the content assets to a different next storage subsystem in the circular sequence.

2. The method recited in claim 1, wherein the differently encoded versions of the content asset are encoded differently in relation to at least one of bitrate, compression, resolution, frame rate, video quality, audio quality, number of channels, or sampling rate.

3. The method of claim 1, wherein the portions of each of the plurality of differently encoded versions of the content asset stored during the first time period and each of the plurality of subsequent time periods are associated with a same playback duration of the content asset.

4. The method of claim 1, wherein shifting the storing of portions of each of the plurality of differently encoded versions of the content assets to different next storage subsystem in the circular sequence is performed, for each differently encoded version, in unison.

5. The method of claim 1, wherein the lengths of each of the first time period and the plurality of subsequent time periods is independently determined based on an available storage capacity of one or more of the plurality of storage subsystems of the circular sequence.

6. The method of claim 1, wherein each of the first time period and the plurality of subsequent time periods has a length, and wherein the lengths of at least some of the first and plurality of subsequent time periods are different.

7. The method of claim 1, wherein the content asset comprises at least one of linear content, non-linear content, video content, audio content, multi-media content, a movie, a television show, a presentation, a song, an album, a live broadcast, recorded content, or stored content.

8. A non-transitory computer-readable medium storing instructions that, when executed, cause:
during a first time period, storing portions of each of a plurality of differently encoded versions of a content asset on different ones of a plurality of storage subsystems, wherein the plurality of storage subsystems forms a circular sequence of storage subsystems; and
repeatedly, at the start of each of a plurality of subsequent time periods, changing the storage subsystems on which portions of each of the plurality of differently encoded versions of the content asset are stored by shifting the storing of portions of each of the plurality of differently encoded versions of the content assets to a different next storage subsystem in the circular sequence.

9. The non-transitory computer-readable medium recited in claim 8, wherein the differently encoded versions of the content asset are encoded differently in relation to at least one of bitrate, compression, resolution, frame rate, video quality, audio quality, number of channels, or sampling rate.

10. The non-transitory computer-readable medium of claim 8, wherein the portions of each of the plurality of differently encoded versions of the content asset stored during the first time period and each of the plurality of subsequent time periods are associated with a same playback duration of the content asset.

11. The non-transitory computer-readable medium of claim 8, wherein shifting the storing of portions of each of the plurality of differently encoded versions of the content assets to different next storage subsystem in the circular sequence is performed, for each differently encoded version, in unison.

12. The non-transitory computer-readable medium of claim 8, wherein the lengths of each of the first time period and the plurality of subsequent time periods is independently determined based on an available storage capacity of one or more of the plurality of storage subsystems of the circular sequence.

13. The non-transitory computer-readable medium of claim 8, wherein each of the first time period and the plurality of subsequent time periods has a length, and wherein the lengths of at least some of the first and plurality of subsequent time periods are different.

14. The non-transitory computer-readable medium of claim 8, wherein the content asset comprises at least one of linear content, non-linear content, video content, audio content, multi-media content, a movie, a television show, a presentation, a song, an album, a live broadcast, recorded content, or stored content.

15. A computing device comprising:
one or more processors; and
memory storing instructions that, when executed by the one or more processors, cause the device to:
cause, during a first time period, storing of portions of each of a plurality of differently encoded versions of a content asset on different ones of a plurality of storage subsystems, wherein the plurality of storage subsystems forms a circular sequence of storage subsystems; and
cause repeatedly, at the start of each of a plurality of subsequent time periods, changing the storage subsystems on which portions of each of the plurality of differently encoded versions of the content asset are stored by shifting the storing of portions of each of the plurality of differently encoded versions of the content assets to a different next storage subsystem in the circular sequence.

16. The computing device recited in claim 15, wherein the differently encoded versions of the content asset are encoded differently in relation to at least one of bitrate, compression, resolution, frame rate, video quality, audio quality, number of channels, or sampling rate.

17. The computing device of claim 15, wherein the portions of each of the plurality of differently encoded versions of the content asset stored during the first time period and each of the plurality of subsequent time periods are associated with a same playback duration of the content asset.

18. The computing device of claim 15, wherein shifting the storing of portions of each of the plurality of differently encoded versions of the content assets to different next storage subsystem in the circular sequence is performed, for each differently encoded version, in unison.

19. The computing device of claim 15, wherein the lengths of each of the first time period and the plurality of subsequent time periods is independently determined based on an available storage capacity of one or more of the plurality of storage subsystems of the circular sequence.

20. The computing device of claim 15, wherein each of the first time period and the plurality of subsequent time periods has a length, and wherein the lengths of at least some of the first and plurality of subsequent time periods are different.
